(19) United States
(12) Patent Application Publication
(10) Pub. No.: US 2021/0309893 A1
(43) Pub. Date: Oct. 7, 2021

(54) ADHESIVE COMPOSITION COMPRISING A BLOCK COPOLYMER HAVING A POLYVINYL AROMATIC BLOCK AND POLY(VINYL AROMATIC/ISOPRENE) BLOCK, ARTICLES, AND METHODS OF BONDING

(71) Applicant: 3M INNOVATIVE PROPERTIES COMPANY, St. Paul, MN (US)

(72) Inventors: Justin M. Bolton, Minneapolis, MN (US); Bradley S. Forney, Cottage Grove, MN (US); Mark D. Purgett, Oakdale, MN (US); Travis Q. Gregar, Maplewood, MN (US)

(21) Appl. No.: 17/262,791

(22) PCT Filed: Oct. 8, 2019
(86) PCT No.: PCT/IB2019/058553

§ 371 Date: Jan. 25, 2021

Related U.S. Application Data
(60) Provisional application No. 62/744,311, filed on Oct. 11, 2018.

(51) Int. Cl. C09J 153/02; C09J 7/38

(52) U.S. Cl. CPC C09J 153/02; C09J 2453/00; C09J 7/387

(57) ABSTRACT

An adhesive composition is described comprising a block copolymer comprising a polyvinyl aromatic block and a poly(vinyl aromatic/isoprene) copolymer block; and a tackifier. The block copolymer typically has the general structure: A−A/B or A−AB−B; wherein A is a polyvinyl aromatic block; B is a polyisoprene block; and A/B is a poly(vinyl aromatic/isoprene) copolymer block. Also described are adhesive articles, methods of bonding, and block copolymer blends.

### SUMMARY

In one embodiment, an adhesive composition is described comprising a block copolymer comprising a polyvinyl aromatic block and a poly(vinyl aromatic/isoprene) copolymer block; and a tackifier.

The block copolymer typically has the general structure:

A−A/B or A−A/B−B

wherein
A is a polyvinyl aromatic block;
B is a polyisoprene block; and
A/B is a poly(vinyl aromatic/isoprene) copolymer block.

In some embodiments, the adhesive composition further comprises a second block copolymer comprising at least two polyvinyl aromatic blocks and one or more conjugated diene blocks.

In some favored embodiments, the adhesive is a pressure sensitive adhesive characterized by properties such as glass transition temperature (Tg), elastic modulus (G′), peel adhesion, shear adhesion, or various combinations of properties.

In one embodiment, a plot of initial 180 degree peel adhesion to stainless steel as a function of the log of the peel propagation rate has a slope less than or equal to 2.66 N*min/in² (6.45 square centimeters). for temperatures ranging from 0° C. to 25° C. and peel propagation rates ranging from 1 inch (2.54 cm)/minute to 20 inches (50.8 cm)/min.

In another embodiment, an adhesive article is described comprising a substrate; and a layer of adhesive composition disposed on the substrate, wherein the adhesive comprises a block copolymer comprising a polyvinyl aromatic block and a poly(vinyl aromatic/isoprene) copolymer block; and tackifier.

In other embodiments, methods of bonding the adhesive or adhesive article are described

In another embodiment, a block copolymer blend is described comprising a first block copolymer comprising a polyvinyl aromatic block and a poly(vinyl aromatic/isoprene) copolymer block; and a second block copolymer comprising at least two polyvinyl aromatic blocks and one or more conjugated diene blocks.

### BRIEF DESCRIPTION OF THE DRAWINGS

FIG. 1 is a nuclear magnetic resonance spectroscopy of an illustrative block copolymer comprising a polystyrene-polyisoprene (non-tapered) diblock (top plot, BD2) in comparison to a block copolymer comprising a polyvinyl aromatic block and a poly(vinyl aromatic/isoprene) copolymer block (bottom plot, TD2);

FIG. 2 is a peel rate master curve for an embodied pressure sensitive adhesive composition.

### DETAILED DESCRIPTION

Presently described are compositions comprising a block copolymer comprising a polyvinyl aromatic block and a poly(vinyl aromatic/isoprene) copolymer block.

In typical embodiments, such block copolymer has the general structure:

A−A/B or A−A/B−B

wherein
A is a polyvinyl aromatic block;
B is polyisoprene block; and
A/B is a poly(vinyl aromatic/isoprene) copolymer block.

For simplicity, the block copolymer will be subsequently referred to as the A−A/B block copolymer. Such terminology is intended to include both structures described above unless specified otherwise.

The poly(vinyl aromatic/isoprene) copolymer block (A/B) may be characterized as a random copolymer. The poly(vinyl aromatic/isoprene) copolymer block (A/B) may also be characterized as tapered, meaning that the block contains a greater number of polymerized vinyl aromatic groups at one end (bonded to the polyvinyl aromatic block) and a greater number of polymerized isoprene groups at the opposing end (bonded to the polyisoprene block).

The polyvinyl aromatic block, A, may be any polyvinyl aromatic block known for block copolymers. The polyvinyl aromatic block is typically derived from the polymerization of vinyl aromatic monomers having 8 to 12 carbon atoms such as styrene, o-methylstyrene, p-methylstyrene, alpha-methylstyrene, p-tert-butylstyrene, 2,4-dimethylstyrene vinylnaphthalene, vinyltoluene, vinylxylene, vinylpyridine, ethylstyrene, t-butylstyrene, isopropylstyrene, dimethylstyrene, other alkylated styrenes, and mixtures thereof. Most typically, the polyvinyl aromatic block is derived from the polymerization of substantially pure styrene monomer or styrene monomer as a major component with minor concentrations of other vinyl aromatic monomers, as described above. The amount of other vinyl aromatic monomer(s) is typically no greater than 10, 9, 8, 7, 6, 5, 4, 3, 2, 1, or 0.5% by weight of the total amount of polymerized vinyl aromatic monomer.

The B block is typically derived from the polymerization of substantially pure isoprene monomer or isoprene monomer as a major component with minor proportions of other conjugated diene monomers having 4 to 12 carbon atoms, such as butadiene, ethyl butadiene; 2,3-dimethyl-1,3-butadiene; phenylbutadiene; 1,3-pentadiene; 1,3-hexadiene, ethyl hexadiene. The amount of other conjugated diene monomer(s) is typically no greater than 10, 9, 8, 7, 6, 5, 4, 3, 2, 1, or 0.5% by weight of the total amount of polymerized conjugated diene. The conjugated diene is typically unsaturated, such as in the case of polyisoprene.

Methods of making (e.g. tapered) A−A/B block copolymers are described in the literature.

The preparation method includes concurrently charging the reactor vessel with both vinyl aromatic monomer (e.g. styrene) and conjugated diene monomer (e.g. isoprene) in the presence of an initiator.

Suitable anionic polymerization initiators include for example, alkyl lithium compounds and other organolithium compounds such as s-butyllithium, n-butyllithium, t-butyllithium, amyllithium and the like, including di-initiators such as the di-sec-butyl lithium adduct of m-diisopropenyl benzene. Other such di-initiators are disclosed in U.S. Pat. No. 6,492,469. Of the various polymerization initiators, n-butyllithium is most commonly utilized.

The initiator can be used in the polymerization mixture (including monomers and solvent) in an amount calculated on the basis of one initiator molecule per desired polymer chain, as known in the art. The polymerization reaction is performed in an oxygen-free and water-free atmosphere.

As known is the art, the reactivity of conjugated diene monomer, such as isoprene, is greater than that of vinyl aromatic monomer, (e.g. styrene). Due to this difference in reactivity, the conjugated diene monomer (e.g. isoprene) initially polymerizes with itself forming a polyconjugated diene (polyisoprene) end block (i.e. B). Once a sufficient amount of conjugated diene monomer (e.g. isoprene) has been polymerized, the vinyl aromatic monomer (e.g. styrene) and conjugated diene monomer (e.g. isoprene) copolymerize with each other forming a (e.g. tapered) copolymer block (i.e. A/B). Once substantially all the conjugated diene monomer (e.g. isoprene) has been consumed, the remaining vinyl aromatic monomer (e.g. styrene) polymerizes with itself forming a polyvinyl aromatic (e.g. polystyrene) end block (i.e. A).

The reaction temperature is typically in the range of −10 to 150° C., and more typically from 10 to 110° C. The reaction is carried out under the pressure high enough to maintain the reaction mixture in a liquid state.

The inert hydrocarbon solvent used as the polymerization vehicle may be any hydrocarbon that does not react with the living anionic chain end and provides the appropriate solubility characteristics for the product polymer. For example, non-polar aliphatic hydrocarbons, that generally lack ionizable hydrogens are particularly suitable solvents. Frequently used are cyclic alkanes, such as cyclopentane, cyclohexane, cycloheptane, and cyclooctane, all of which are relatively non-polar. Other suitable (e.g. polar) solvents will be known to one skilled in the art and can be selected to perform effectively in a given set of process conditions, with temperature being one of the major factors.

As known in the art, polymerization of the conjugated diene block can be modified to control the vinyl content. This can be done by utilizing an organic polar compound such as an ether, including cyclic ethers, polyethers and thioethers or an amine including secondary and tertiary amines. Both non-chelating and chelating polar compounds can be used.

Suitable polar compounds include fore example dimethyl ether, diethyl ether, ethyl methyl ether, ethyl propyl ether, dioxane, dibenzyl ether, diphenyl ether, dimethyl sulfide, diethyl sulfide, tetramethylene oxide (tetrahydrofuran), tripropyl amine, tributyl amine, trimethyl amine, triethyl amine, pyridine and quinoline and mixtures thereof.

A “chelating ether” means an ether having more than one oxygen as exemplified by the formula R(OR′)ₘ (OR″)ₒOR where each R is individually selected from 1 to 8, typically 2 to 3, carbon atom alkyl radicals; R′ and R″ are individually selected from 1 to 6, typically 2 to 3, carbon atom alkylene radicals; and m and o are independently selected integers of 1-3, typically 1-2. Examples of preferred ethers include diethoxypropane, 1,2-dioxyethane (dioxo) and 1,2-dimethyoxyethane (glyme), or mixtures thereof. Other suitable materials include —CH₃, —OCH₂, —CH₂, and —OCH₃ (diglyme), or mixtures thereof “Chelating amine” means an amine having more than one nitrogen such as N,N,N′,N′-tetramethylethylene diamine.

In typical embodiments, no organic polar compounds are utilized during the polymerization of the A−A/B block copolymer.

Alternatively, an amount of polar modifier can be utilized to obtain the desired vinyl content in the conjugated diene block. The polar modifier can be utilized in an amount of at least 0.1 moles per mole of (e.g. lithium) initiator compound, typically 1-50, more typically 2-25 moles of polar modifier per mole of the (e.g. lithium) initiator compound.

After the completion of the polymerization reaction, water, alcohol, phenol, or an active hydrogen compound such as dicarboxylic acid is added to convert the carbon-lithium bonds of the active polymer to carbon-hydrogen bonds, thereby terminating the reaction. Subsequently, the A−A/B block copolymer polymer material is isolated. The most common polymerization terminators are water and carbon dioxide. However, alcohols (e.g. isopropanol) are also commonly used for small laboratory-scale production.

The A−A/B block copolymer can be precipitated (e.g. from methanol) and dried. Alternatively, a stabilizer can be added with the polymerization terminator, and the solvent removed using steam to produce a polymer crumb, that can be dried out with a roll mill at 110° C. Suitable stabilizers are known in the art, such as a mixture of hindered phenol-based compound and organophosphite-based compound.

The content of polymerized units of vinyl aromatic monomer(s), such as styrene, typically ranges from 10 to 50 wt. % based on the total weight of the A−A/B block copolymer. Thus, the content of polymerized units of vinyl aromatic monomer(s) includes the polymerized units of the polyvinyl aromatic end block (A) as well as the polymerized vinyl aromatic monomer(s) of the poly(vinyl aromatic/isoprene) copolymer block (A/B). In some embodiments, the A−A/B block copolymer has a polymerized vinyl aromatic monomer (e.g. styrene) content of at least 15 or 20 wt. % based on the total weight of the A−A/B block copolymer. In some embodiments, the A−A/B block copolymer has a polymerized vinyl aromatic monomer (e.g. styrene) content of no greater than 45, 40, 35 or 30 wt. % based on the total weight of the A−A/B block copolymer.

The concentration of polymerized vinyl aromatic monomer(s), such as styrene, of the (e.g. tapered) poly(vinyl aromatic/isoprene) copolymer block (A/B) is typically at least 1, 2, 3, 4, 5, 6, 7, 8, 9, or 10 wt. %. In some embodiments, the concentration of polymerized vinyl aromatic monomer(s), such as styrene, of the poly(vinyl aromatic/isoprene) copolymer block (A/B) is no greater than 30, 29, 28, 27, 26, 25, 24, 23, 22, 21, or 20 wt. %. In some embodiments, the concentration of polymerized vinyl aromatic monomer(s), such as styrene, of the poly(vinyl aromatic/isoprene) copolymer block (A/B) is no greater than 19, 18, 17, 16, or 15 wt. %. Thus, the poly(vinyl aromatic/isoprene) copolymer block (A/B) typically comprises at least 70, 71, 72, 73, 74, 75, 76, 77, 78, 79, 80, 81, 82, 83, 84, 85, 86, 87, 88, 89, 90, 91, 92, 93, 94, 95, 96, 97, 98, or 99 wt. % of polymerized conjugated diene (e.g. isoprene).

The number average molecular weight of the A−A/B block copolymer typically ranges from 50,000 to 250,000 g/mole. In some embodiments, the number average molecular weight of the A−A/B block copolymer is at least 60,000; 70,000; 80,000; 90,000; or 100,000 g/mole. In some embodiments, the number average molecular weight of the A−A/B block copolymer is no greater than 200,000, 175,000, or 150,000 g/mole.

The term “molecular weight” refers to the molecular weight in g/mole of the total block copolymer as can be measured with gel permeation chromatography (GPC) using polystyrene calibration standards, according to the test method described in the examples using light scattering detection.

The polydispersity of the A−A/B block copolymer ranges from 1 to 1.5. In some embodiments, the polydispersity is no greater than 1.40, 1.35, 1.30, 1.25, 1.20, 1.15, 1.10, or 1.05.

The A−A/B block copolymer described herein can be characterized as a linear block copolymer.

In contrast, preparation of radial (branched) polymers requires a post-polymerization step called “coupling”. Therefore, radial (branched) polymers include residues of a variety of coupling agents such as dihalo alkanes, silicon halides, siloxanes, multifunctional epoxides, silica compounds, esters of monohydric alcohols with carboxylic acids, (e.g. dimethyl adipate) and epoxidized oils. Silane coupling agents include tetra-alkoxysilanes such as tetra-ethoxysilane (TEOS) and tetra-methoxysilane, alkyl-trialkoxysilanes such as methyl-trimethoxy silane (MTMS), aliphatic diesters such as dimethyl adipate and diethyl adipate, and diglycidyl aromatic epoxy compounds such as diglycidyl ethers deriving from the reaction of bis-phenol A and epichlorohydrin. As described in the literature star-shaped polymers are prepared with polyalkenyl coupling agents such as divinylbenzene, and typically m-divinylbenzene. The A−A/B block copolymer described herein is substantially free of such coupling agents. However, the adhesive composition can contain a second block copolymer that comprises such coupling agents.

In one embodiment, a block copolymer blend is described comprising a first block copolymer comprising a polyvinyl aromatic block and a (e.g. tapered) poly(vinyl aromatic/isoprene) copolymer block and a second different block copolymer.

The second block copolymer may have various structures including a linear A-B-A triblock block copolymers and (A-B)nX radial (e.g. multi-arm) block copolymer wherein A is a polyvinyl aromatic blocks, B is a conjugated diene block, n is an integer of at least 2 or 3, typically ranging up to 6, 7, 8, 9, 10, 11, or 12 and X is the residue of a coupling agent. Such block copolymers generally comprise two or more polyvinyl aromatic blocks, such as polystyrene.

The second block copolymer can further comprise appreciable amounts of A-B diblock wherein A is a polyvinyl aromatic block and B is a conjugated diene block. For example, the diblock content may be at least 15, 20, 25, or 30 wt. % of the total second block copolymer. In some embodiments, the diblock content of the second block copolymer is typically no greater than 70, 60, 50, or 40 wt. % of the total second block copolymer. In typical embodiments, the second block copolymer comprises at least two polyvinyl aromatic blocks and one or more conjugated diene blocks. The polyvinyl aromatic blocks can be prepared from the same vinyl aromatic monomers previously described. The one or more conjugated diene blocks can be prepared from any of the conjugated diene monomers typically utilized in the preparation of vinyl aromatic (e.g. styrene) block copolymer, especially isoprene.

Various types of styrene-isoprene-styrene (SIS) block copolymers are commercially available, such as under the trade designation KRATON™ D. The unsaturated midblock of the second block copolymer can be tapered or non-tapered, but is typically non-tapered.

In some embodiments, the content of polymerized units of vinyl aromatic monomer(s) (e.g. styrene) of the second block copolymer is in the same range as the A−A/B block copolymer, as previously described.

In other embodiments, the second block copolymer has a lower content of polymerized units of vinyl aromatic monomer(s) (e.g. styrene) than the A−A/B block copolymer. For example, in one embodiment, the A−A/B block copolymer has a polymerized vinyl aromatic monomer (e.g. styrene) content ranging from 20 to 30 wt. % and the second block copolymer has a polymerized vinyl aromatic monomer (e.g. styrene) content of less than 20 wt. %. In some embodiments, the second block copolymer has a polymerized vinyl aromatic monomer (e.g. styrene) content of at least 5, 6, 7, 8, 9, or 10 wt. % ranging up to about 15 wt. % based on the total weight of the second block copolymer.

In some embodiments, the second block copolymer has a molecular weight in the same range as the A−A/B block copolymer, as previously described.

In other embodiments, the second block copolymer has a higher molecular weight than the A−A/B block copolymer. In some embodiments, the second block copolymer has a number average molecular weight of at least 300,000; 400,000; or 500,000 g/mol. In some embodiments, the second block copolymer has a number average molecular weight of at least 600,000; 700,000; 800,000; 900,000 or 1,000,000 g/mol. In some embodiments, the second block copolymer has a number average molecular weight of at least 1,250,000 or 1,500,000. The molecular weight of the second block copolymer is typically no greater than 1,750,000 or 2,000,000 g/mole.

In some embodiments, the molecular weight of the polyvinyl aromatic (e.g. polystyrene) end blocks of the second block copolymer is about the same and the second block copolymer may be characterized as symmetrical. In other embodiments, the molecular weight of the polyvinyl aromatic (e.g. polystyrene) end blocks is different and the second block copolymer may be characterized as asymmetrical. In some embodiments, the number average molecular weight of the lower molecular weight polyvinyl aromatic (e.g. polystyrene) end block is at least 1,000 to about 10,000 g/mole, typically from about 2,000 to about 9,000 g/mole, more typically between 4,000 and 7,000 g/mole. The number average molecular weight of the higher molecular weight polyvinyl aromatic (e.g. polystyrene) end block is in the range from about 5,000 to about 50,000 g/mole, typically from about 10,000 to about 35,000 g/mole.

In some embodiments, the number of arms of the second block copolymer containing a higher molecular weight end block is at least 5, 10 or 15 percent of the total number of arms of the second block copolymer. In some embodiments, the number of arms containing a higher molecular weight end block is no greater than 70, 65, 60, 55, 50, 45, or 35 percent of the total number of arms of the second block copolymer.

The asymmetrical second block copolymer typically comprises from about 4 to 40 percent by weight of a polyvinyl aromatic monomer (e.g. polystyrene), and from about 96 to 60 percent by weight of a polymerized conjugated diene(s). In some embodiments, the asymmetrical second block copolymer comprises from about 5 to 25 percent of a polymerized vinyl aromatic monomer (e.g. styrene) and from about 95 to 75 percent of a polymerized conjugated diene, and more typically from about 6 to 15 percent of a polymerized vinyl aromatic monomer and from about 94 to 85 percent of polymerized conjugated diene.

Especially at lower concentrations of polymerized units of vinyl aromatic monomers (e.g. styrene) the A−A/B block copolymer can be difficult to finish into a solid crumb or pellet form. Inclusion of a second, higher molecular weight and/or higher styrene content block copolymer can improve the processability of the block copolymer blend.

The weight ratio of second block copolymer to A−A/B block copolymer can vary. In some embodiments, the amount by weight of the second block copolymer is equal to or greater than the amount of A−A/B block copolymer. In some embodiments, the weight ratio of second block copolymer to A−A/B block copolymer ranges from 1:1 to 20:1. In some embodiments, the weight ratio of second block copolymer to A−A/B block copolymer is at least 1.1:1; 1.2:1; 1.3:1; 1.4:1; or 1.5:1 (or in other words 3:2). In some embodiments, the weight ratio of second block copolymer to A−A/B block copolymer is no greater than 15:1, 10:1, 5:1, 4:1, 3:1, or 2:1.

The A−A/B block copolymer alone or in combination with a second block copolymer can be utilized and provide beneficial properties in a variety of adhesives including hot melt adhesives and solvent-based adhesives.

The adhesive composition generally comprises at least 25, 30, 35, 40, 45, 50, or 60 wt. % of the A−A/B block copolymer alone or in combination with a second block copolymer, based on the total weight of organic components of the adhesive. In some embodiments, the amount of −A/B block copolymer alone or in combination with a second block copolymer is no greater than 80, 75, 70, or 65 wt. %.

The adhesive composition comprising the A−A/B block copolymer (e.g. A−A/B−B), as described herein, further comprises tackifying resin.

Tackifying resins include both A block compatible resins and B block compatible resins. The A block compatible resin may be selected from the group consisting of coumarone-indene resin, rosin ester resin, polyindene resin, poly(methyl indene) resin, polystyrene resin, vinyltoluene-alphamethylstyrene resin, alphamethylstyrene resin and polyphenylene ether, in particular poly(2,6-dimethyl-1,4-phenylene ether) or mixture of two or more of these. Such resins are e.g. sold under the trademarks “HERCURES”, “ENDEX”, “KRISTALEX”, “NEVCHEM”, “SYLVALITE” and “PICCOTEX”. The preferred A block compatible tackifying resin is a rosin ester tackifying resin sold under the trade name “SYLVALITE.”

Resins compatible with the B block maybe selected from the group consisting of compatible C5 hydrocarbon resins, hydrogenated C5 hydrocarbon resins, styrenated C5 resins, C5/C9 resins, polyterpenes, terpene phenolic resins, fully hydrogenated or partially hydrogenated C9 hydrocarbon resins, rosin esters, rosin derivatives and mixtures thereof. These resins are sold under the trademarks “REGALITE”, “REGALREZ”, “ESCOREZ”, “WINGTACK”, “SLYVARES” and “ARKON”. One preferred B block compatible tackifying resin is a C5 tackifying resin sold under the trade name “ZEON QUINTONE K100.”

In typical embodiments, the tackifying resin has a softening point of at least 85° C., 100° C., or 110° C. and typically no greater than 135° C. or 120° C.

Although the composition of the present invention can have a combination of resins compatible with A blocks and/or B blocks, in some favored embodiments, the adhesive composition comprise solely or predominantly midblock tackifying resin. In this embodiment, the amount of tackifying resin compatible with the A block is no greater than 10, 9, 8, 7, 6, 5, 4, 3, 2, or 1 wt. % based on the total weight of the organic components of the adhesive composition.

The amount of (e.g. B block compatible) tackifying resin varies from about 10 to about 75 wt. % depending on the type of tackifier, based on the total weight of the organic components of the adhesive composition. In some embodiments, the adhesive composition comprises at least 15, 20, 25, or 30 wt. % of (e.g. B block compatible) tackifying resin. In some embodiments, the adhesive composition comprises no greater than 65, 60, 55, 50 or 45 wt. % of (e.g. B block compatible) tackifying resin.

Plasticizers, such as oils, are commonly included in pressure sensitive adhesive compositions. In some embodiments, the plasticizer (e.g. oil) is compatible with the B blocks. Petroleum-based oils having less than 50% aromatic content are typically preferred. Such oils include both paraffinic and naphthenic oils. The oils should additionally have low volatility, typically having an initial boiling point above about 500° F.

Alternative plasticizers include oligomers of randomly or sequentially polymerized styrene and conjugated diene, oligomers of conjugated diene, such as butadiene or isoprene, liquid polybutene-1, and ethylene-propylene-diene rubber. Such alternative plasticizers are generally low or high viscosity liquids having a number average molecular weight in the range from 300 to 25,000; 30,000; or 35,000 g/mole.

The pressure sensitive adhesive may optionally comprise plasticizer is an amount ranging from 10 to 35 or 45 wt. % of the organic components of the adhesive composition. In some embodiments, the pressure sensitive adhesive composition comprises no greater than 10, 9, 8, 7, 6, 5, 4, 3, 2, 1 wt. % of plasticizer.

In some embodiments, the adhesive compositions herein include one or more additives such as antioxidants, (e.g. ultraviolet and thermal) stabilizers, colorant, antimicrobial agent, filler, crosslinker, and combinations thereof.

Antioxidants can include various agents including, but not limited to, phenols (including but not limited to hindered phenolics and bisphenolics), mercaptan group containing compounds (including, but not limited to thioethers, thioesters, and mercapto-benzimidazoles), di-hydroquinolines, hydroquinones, lactates, butylated paracresols, amines, unsaturated acetals, fluorophosphonites, phosphites, and blends of these. It will be appreciated that these groups are not exclusive in some cases. By way of examples, a phenolic compound could also have a mercaptan group.

In some embodiments, the adhesive comprises an amount of antioxidant greater than 0.01 wt. %, 0.05 wt. %, 0.1 wt. %, 0.2 wt. %, 0.3 wt. %, 0.4 wt. %, 0.5 wt. %, 1.0 wt. %, 1.5 wt. %, or greater than 2.0 wt. % based on the total weight of the adhesive. In some embodiments, the amount of the antioxidant used is less than 5 wt. %, 4 wt. %, 3 wt. %, 2.5 wt. %, 2 wt. %, 1.5 wt.

%, or 1.0 wt. %, 0.8 wt. %, or 0.5 wt. %. In some embodiments, the amount of the antioxidant can be in a range of about 0.10 wt. % to about 2.0 wt. %.

In some embodiments, the adhesive composition is a pressure sensitive adhesive. Pressure sensitive adhesives generally have a glass transition temperature (Tg) below room temperature, i.e. less than 25° C. In some embodiments, the (e.g. pressure sensitive) adhesive described herein has a Tg no greater than 0° C., −5° C., −10° C., or −15° C. as determined with the rheology (dynamic mechanical analysis) test method described in the examples with a frequency of 1 Hz. In some embodiments, the (e.g. pressure sensitive) adhesive exhibits a single Tg, or in other words a single phase, for the tackified isoprene and butadiene midblocks.

The “Dahlquist Criterion for Tack” is widely recognized as a necessary condition of a pressure sensitive adhesives (PSA). It states that a PSA has a shear storage modulus (G′) of less than 3×10⁶ dyne/cm² (0.3 MPa) at approximately room temperature (25° C.) and a frequency of 1 Hz (Pocius, Adhesion and Adhesive Technology 3^{rd} Ed., 2012, p. 288). In some embodiments, the adhesive described herein has a shear storage modulus (G′) of at least 0.05 MPa or 0.1 MPa at approximately room temperature (25° C.) and a frequency of 1 Hz.

In some embodiments, the pressure sensitive adhesive composition described herein exhibits an initial 180 degree peel adhesion to stainless steel (as determined according to the test method described in the examples) of at least 1, 2, 3, 4, or 5 N/cm at a peel rate of 32 cm/minutes. In some embodiments, the 180 degree peel adhesion to stainless steel is at least 6, 7, 8, 9, or 10 N/cm at a peel rate of 32 cm/minutes. In some embodiments, the 180 degree peel adhesion to stainless steel is no greater than 50, 40, 30, or 20 N/cm.

In some embodiments, the pressure sensitive adhesive composition described herein exhibits a shear adhesion force to stainless steel (as determined according to the test method described in the examples) of at least 10,000+ minutes. In other embodiments, a high shear adhesion force may not be of importance.

In some embodiments, the pressure sensitive adhesive composition described herein exhibits a shear adhesion force to painted drywall (as determined according to the test method described in the examples) of at least 5,000; 10,000 or 25,000+ minutes. The paint may be Interior Acrylic Latex Ben Bone White Paint obtained from Sherwin Williams.

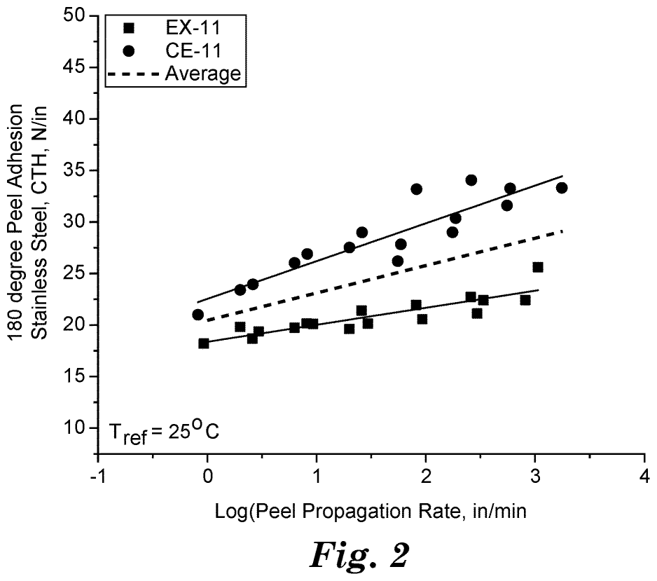

FIG. 2 depicts initial 180 degree peel adhesion to stainless steel (y-axis) plotted as a function of the log of the peel propagation rate for an embodied adhesive composition, EX. 11, in comparison to CE-11 at 25° C. Peel propagation rates were calculated by dividing the crosshead speed of an initial 180 degree peel adhesion to stainless steel result by two. Several of the data points of FIG. 2 were measured directly. Only data points in the linear region where the adhesive cleanly removed from the stainless steel were included in the plot. Samples that were cohesively failing or “shocky” were not included. Other data points were calculated using compliance master curves generated from rheological analysis (according to the test method further described in the examples) and time-temperature superposition utilizing the Williams-Landel-Ferry (WLF) Equation.

EX. 11 and CE-11 contain the same kind and amount of second block copolymer (35.09 wt. % of K1340), the same kind and amount of tackifier (40.94 wt-% of ZQK100), and the same kind and amount of antioxidant (0.68 wt. % of 11520). EX. 11 also contain 35.09 wt. % of a block copolymer comprising a polyvinyl aromatic end block and a (e.g. tapered) poly(vinyl aromatic/isoprene) copolymer block (A−A/B); whereas CE-11 contains 35.09 wt. % of a block copolymer comprising a non-tapered polyvinyl aromatic/polyisoprene diblock (A-B).

The bottom plot of FIG. 2, corresponding to EX-11, has a slope of 1.66 N*min/in² and y-intercept of 18.37 N/in with an R² value of 0.77. The top plot, CE-11, has a slope of 3.66 N*min/in² and y-intercept of 22.54 N/in with an R² value of 0.83. A reference plot labeled as “average” is also included, having a slope of 2.66 N*min/in² and a y-intercept of 20.45 N/in.

It is evident from FIG. 2, that EX-11, an adhesive composition comprising a (e.g. tapered poly(vinyl aromatic/isoprene) copolymer block, as described herein, has a slope less than the average slope of 2.66 N*min/in². The slope can be less than 2.6, 2.5, 2.4, 2.3, 2.2, 2.1, 2.0, 1.9, 1.8, 1.7, or 1.6 N*min/in². The slope can approach zero for a temperature of 25° C. and peel propagation rates ranging from 1 inch (2.54 cm)/minute to 20 inches (50.8 cm)/min. For lower temperatures, e.g. 0° C. and 10° C., the slope is typically at least 0.5, 1, 1.2, 1.3, 1.4, or 1.5 N*min/in². A lower slope value indicates a lower increase in initial 180 degree peel adhesion as a function of increasing peel (e.g. propagation) rate. Thus, when an adhesive article, such as a tape is removed from a surface, the removal force is more similar regardless of whether the tape is removed quickly or more slowly.

The (e.g. pressure sensitive) adhesive compositions can be prepared by dissolving the A−A/B block copolymer, second block copolymer when present, tackifying resin, and other optional components in an organic solvent. Suitable solvents for mixing and coating the pressure sensitive adhesive compositions herein include aromatic, aliphatic, cycloaliphatic, and aralkyl compounds, as well as ketones, aldehydes, alcohols, or esters that are liquids at least between about 20° C. to 85° C. and dissolve or disperse the components of the pressure sensitive adhesive composition sufficiently to form a suitably homogeneous coating on the adhesive article at the targeted coating temperature. In some embodiments, heptane, cyclohexane, benzene, toluene, xylene, naphthalene, acetone, methyl ethyl ketone, acetaldehyde, propionaldehyde, ethyl acetate, isopropyl alcohol, butyl alcohol, and the like, and mixtures thereof, are suitable coating solvents.

The (e.g. pressure sensitive) adhesive compositions can contain 1 wt. % to 90 wt. % solids in the solvent or solvent mixture. In some embodiments, the adhesive coating contains at least 10, 20, 30, or 40 wt. % solids in the solvent or solvent mixture. In some embodiments, the adhesive coating contains no greater than 80, 70, or 60 wt. % solids in the solvent or solvent mixture.

In some embodiments, the (e.g. pressure sensitive) adhesive compositions described herein are coated and/or laminated onto a substrate, such as a (e.g. tape) backing or release liner, to form a coated layer disposed on one or more portions of one or more major surfaces thereon. Conventional solvent coating techniques such as knife coating, die coating, bar coating, slot coating, brush coating, dip coating, spray coating, and the like can be utilized. After coating, the solvent is removed to result in an adhesive layer. In some embodiments, heat, forced air, or both are employed to remove the solvent. After drying, in embodiments where the adhesive layer is coated on a liner, the liner can then be laminated to the substrate (e.g. backing). The laminating step includes contacting the adhesive layer to the substrate and may include application of pressure, heat, or both. Alternatively, the (e.g. pressure sensitive) adhesive compositions described herein may be prepared as a solvent-less hot melt adhesive and coated molten.

In some embodiments the surface of the substrate (e.g. backing) is treated by flame treatment, air corona treatment, nitrogen corona treatment, or some other surface treatment to impart better adhesion of the pressure sensitive adhesive layer when coated thereon. In other embodiments, a layer of primer is coated from a liquid composition to form a dried layer less than 1 μm thick on the surface of the substrate (e.g. backing), or in some embodiments 1 to 10 μm thick; the primer is a material that improves adhesion of the pressure sensitive adhesive layer to the substrate (e.g. backing). In still other embodiments, the substrate (e.g. backing) is extrusion coated or coextruded with one or more additional layers of resin to impart interlayer adhesion; such layers are often referred to as “tie layers.” Tie layers are layers containing material that has acceptable interlayer adhesion to both the layer onto which it is deposited and the layer that is deposited on top of it; such tie layers provide sufficient interlayer adhesion for the selected application. A tie layer is present, in some embodiments, between coextruded layers of the substrate (e.g. backing); in other embodiments, the tie layer is extruded onto an exposed surface and provides adhesion between the pressure sensitive adhesive and the substrate (e.g. backing).

The (e.g. pressure sensitive) adhesive layer has thickness ranging from 1 μm to 1 mm thick, or about 10 μm to 500 μm thick, or about 25 μm to 300 μm thick, or about 25 μm to 200 μm thick, or about 25 μm to 100 μm thick. In some embodiments, the layer of pressure sensitive adhesive composition is substantially continuous. In other embodiments, the layer of pressure sensitive adhesive composition is discontinuous. In some such embodiments, the layer is present as e.g., dots or stripes. The discontinuous coating may form a pattern.

In some embodiments, adhesive articles are described that include a substrate (e.g. backing, release liner) and a layer of pressure sensitive adhesive described herein, disposed on the substrate. The adhesive is coated on at least a portion of one major surface of the substrate (e.g. backing). In some embodiments, one major surface of the substrate (e.g. backing) is coated with the adhesive composition. In other embodiments, portions of both major surfaces of the substrate (e.g. backing) are coated with an adhesive composition.

The substrate (e.g. backing) is typically a substantially planar film or layer having two major opposing surfaces. The thickness of the substantially planar film or layer is orthogonal to the major opposing surfaces. The (e.g. major surface of the) substrate (e.g. backing) can be any desired shape including, for example, square, rectangle, triangular, polygon, circular, quadrilateral, trapezoidal, cylindrical, half-circular, star-shaped, half-moon shaped, tetrahedral, etc.

The thickness of the substrate (e.g. backing) is not particularly limited. In some embodiments, the thickness of the substrate (e.g. backing) is at least 1, 5, 10, 25, or 50 μm. In some embodiments, the thickness of the substrate (e.g. backing) is no greater than 10, 5, 2.5, or 1 mm. In some embodiments, the substrate (e.g. backing) has a thickness of greater than 5 mils, greater than 8 mils, greater than 10 mils, greater than 12 mils, greater than 15 mils, greater than 20 mils, greater than 22 mils, or greater than 24 mils. In some embodiments, the backing has a thickness of less than 100 mils, less than 90 mils, less than 80 mils, less than 75 mils, less than 70 mils, less than 65 mils, less than 60 mils, less than 55 mils, less than 50 mils, less than 45 mils, less than 40 mils, less than 38 mils, less than 35 mils, less than 32 mils, less than 30 mils, less than 28 mils, or less than 25 mils.

The substrate (e.g. backing) can be a single layer or a multilayer construction. More than one backing layer can be present in the backing. Multiple backing layers can be separated by layers of film, which may further contain one or more layers. In some embodiments, the backing includes at least one of plastic, metal, paper, nonwoven material, textile, woven material, foam, adhesive, gel, and/or a filament reinforced material. In some embodiments, the backing is at least one of a single layer of material or a multilayer film. In other embodiments, the backing can be an arrangement of particles disposed between adjacent adhesive layers.

In some embodiments, two or more sub-layers can be co-extruded so as to form the backing. In some embodiments, the backing is flexible. Some embodiments include dyes or pigments in the backing layer. Some embodiments include at least one tackifier in at least one layer of the backing. Some embodiments include a plasticizing oil in one or more layers of the backing.

The substrate (e.g. backing) can be made of any desired material or materials. Representative examples of materials suitable for the substrate (e.g. backing) can include, for example, polyolefins, such as polyethylene, including high density polyethylene, low density polyethylene, linear low density polyethylene, and linear ultralow density polyethylene, polypropylene, polybutylenes; vinyl copolymers, such as polyvinyl chlorides, both plasticized and unplasticized, and polyvinyl acetates; olefinic copolymers, such as ethylene/methacrylate copolymers, ethylene/vinyl acetate copolymers, acrylonitrile-butadienestyrene copolymers, and ethylene/propylene copolymers; acrylic polymers and copolymers; polyurethanes; polyamides; polyesters; polycarbonates; as well as mixtures and copolymers thereof. Suitable mixtures include for example polypropylene/polyethylene, polyurethane/polyolefin, polyurethane/polycarbonate, and polyurethane/polyester.

In some embodiments, a natural material such as paper or composite mixtures of paper and one or more thermoplastic materials are employed as the substrate (e.g. backing).

In some embodiments, the substrate (e.g. backing) is or includes a composite foam that includes a flexible polymeric foam layer, a first film laminated to a first major surface of the foam layer, and a second film laminated to a second, opposite major surface of the foam layer. Adhesive(s) can be attached to the films to form a structure of adhesive-film-foam-film-adhesive. The flexible polymeric foam layer can be chosen to optimize conformability and resiliency properties which are helpful when an adhesive article is to be adhered to surfaces having surface irregularities. Such is the case with a typical wall surface. An exemplary flexible polymeric foam layer is commercially available under the trade designation “Command” from 3M Company of St. Paul, Minn. In some embodiments, the flexible polymeric foam layer of the backing can include polyolefin foams which are available under the trade designations “Volextra” and “Volara” from Voltek, Division of Sekisui America Corporation, Lawrence, Mass. In some embodiments, the backing is or includes a metal or is metal-like. In some embodiments, the backing is or includes wood or is wood-like.

The substrate (e.g. backing) can be or include one of the materials or backings described in any of the following patent applications, all of which are incorporated in their entirety herein: US Provisional Application Nos. (assigned to the present applicant) 62/622,387, 62/526,200, and 62/477,844; PCT Application No. US2017/016039 (Runge et al.); and WO Publication No. 2015/195344, all assigned to the present assignee.

In some embodiments, the substrate (e.g. backing) material has a storage modulus of between about 15×10³ Pa and about 2.5×10⁶ Pa at 25 degrees Celsius. In other embodiments including those with glass materials or other ceramics, the backing material can have a storage modulus of up 1×10¹⁰ Pa. In some embodiments, the backing material has a tan δ (where tan δ is the loss modulus divided by the storage modulus) of between about 0.4 and about 1.2 at 25 degrees Celsius. In some embodiments, the backing has a glass transition temperature of between about −125 and about 40 degrees Celsius. In other embodiments, the backing material has a stress relaxation between 10% and 100% after 10 seconds.

In some embodiments, the substrate (e.g. backing) exhibits an elastic recovery of 1-99% at 10% strain. In some embodiments, the backing exhibits an elastic recovery of 1-99% at 20% strain. In some embodiment of the disclosure, the backing material has an elongation at break of greater than 50% in at least one direction. In some embodiment of the disclosure, the backing material has an elongation at break of between about 50% and about 1200% in at least one direction.

In some embodiments, the substrate (e.g. backing) has a Young's modulus of between about 100 psi and about 100,000 psi. In other embodiments featuring glass materials or ceramics, the backing may have a Young's modulus of up to 10,000,000 psi. In some embodiments, the backing exhibits an elastic recovery of 1-100% at 10% strain as measured by ASTM D5459-95. In some embodiments, the backing exhibits an elastic recovery of 1-100% at 20% strain.

In some embodiments, the substrate (e.g. backing) has a modulus of elasticity and/or a modulus of secant of between about 100 psi and about 15,000 psi as determined by at least one of ASTM D638-14 and ASTM D412-06a. In some embodiments, the backing has a modulus ranging between 100 psi and 15000 psi. In some embodiments the modulus is greater than 100 psi, greater than 500 psi, greater than 1000 psi. In some embodiments the backing modulus is less than 15000 psi, less than 10000 psi, less than 8,000 psi, less than 5,000 psi, less than 3,500 psi, less than 2000 psi, and less than 1500 psi.

In some embodiments, the adhesive articles include at least one release liner disposed on the exposed surface of a layer of pressure sensitive adhesive composition to protect the adhesive composition until use. Liners are substantially planar films or layers having two opposing major sides defining a thickness, wherein at least one major side thereof contacts an adhesive layer of the adhesive article prior to use, and wherein the liner is removable by the user; and wherein upon removal, the liner includes substantially no adhesive. Examples of suitable liners include, e.g., paper such as kraft paper, polymer films such as polyethylene, polypropylene and polyester films, and combinations thereof. In embodiments, the liner is a release liner. In embodiments, a release liner is a liner wherein at least one major side thereof includes a release agent layer resulting from a release treatment to form a release liner. Examples of useful release agents include silicone (polydimethyl siloxane) or silicone copolymers such as silicone acrylates, silicone polyurethanes and silicone polyureas; fluorochemicals such as fluorosilicones or perfluoropolyethers; or other relatively low surface-energy compositions based on urethanes, acrylates, polyolefins, low density polyethylene, and the like, and combinations thereof. Suitable release liners and methods for treating liners are described in, e.g., U.S. Pat. Nos. 4,472,480; 4,980,443; and 4,736,048, all of which are incorporated herein by reference in their entirety.

In some embodiments, the adhesive article includes one or more non-adhesive areas, as described in WO 2018/039584; incorporated herein by reference.

The (e.g. pressure sensitive) adhesive and adhesive article (e.g. tape) described herein can be used in various methods of bonding. In one embodiment, a method of bonding is described comprising providing a (e.g. pressure sensitive) adhesive composition as described herein, applying the adhesive composition to a substrate; and contacting the adhesive to a surface. In another embodiment, the method of bonding is described comprising providing an adhesive article comprising a substrate and a layer of (e.g. pressure sensitive) adhesive disposed on the substrate; and contacting the layer of adhesive to a surface. In some embodiments, the adhesive described herein may be used to adhere a mounting device such as a hook, clip, magnet, detachable mechanical fastener, snap, loop, or detachable mechanical fastener to a (e.g. painted) surface.

Some embodiments of the invention are as follow:

### Embodiment 1

An adhesive article comprising:

a substrate; and
a layer of adhesive composition disposed on the substrate, wherein the adhesive comprises a block copolymer comprising a polyvinyl aromatic block and a poly(vinyl aromatic/isoprene) copolymer block; and tackifier.

### Embodiment 2

The adhesive article of embodiment 1 wherein the substrate is a release liner or a film.

### Embodiment 3

The adhesive article of embodiments 1 or 2 wherein the adhesive is further characterized as described by the claims.

### Embodiment 4

A method of bonding comprising:

providing an adhesive composition to the claims;
applying the adhesive composition to a substrate;
contacting the adhesive to a surface.

### Embodiment 5

A method of bonding comprising:

providing an adhesive article according to the claims; and
contacting the layer of adhesive to a surface.

### Embodiment 6

A block copolymer blend comprising a first block copolymer comprising a polyvinyl aromatic block and a poly(vinyl aromatic/isoprene) copolymer block, and a second block copolymer comprising at least two polyvinyl aromatic blocks and one or more conjugated diene blocks.

### Embodiment 7

The block copolymer blend of Embodiment 6 wherein the block copolymer comprising the polyvinyl aromatic block and poly(vinyl aromatic/isoprene) copolymer block or second block copolymer is further characterized as described by the claims.

### EXAMPLES

Unless otherwise noted, all parts, percentages, ratios, etc. in the Examples and the rest of the specification are by weight. Unless otherwise indicated, all other reagents were obtained, or are available from fine chemical vendors such as Sigma-Aldrich Company, St. Louis, Mo., or may be synthesized by known methods. Table 1 (below) lists materials used in the examples and their sources.

TABLE 1
Materials List

| DESIGNATION | DESCRIPTION | SOURCE |
|---|---|---|
| CHX | Cyclohexane, OMNISOLV HPLC grade | Sigma-Aldrich, St. |
| | | Louis, MO, USA |
| Isoprene | Isoprene, 99% | Sigma-Aldrich |
| Calcium hydride | calcium hydride, 95% | Sigma-Aldrich |
| di-n-butlymagnesium | di-n-butlymagnesium, 1.0 Molar in heptane | Sigma-Aldrich |
| Styrene | Styrene, 99% | Sigma-Aldrich |
| sec butyl lithium | sec butyl lithium, 1.7 Molar in hexanes | FMC Corporation, |
| | | Philadelphia, PA, |
| | | USA |
| KD1340 | An asymmetric multi-arm star, styrene- | Kraton Corporation, |
| | isoprene block copolymer having 9% styrene | Houston, TX, USA |
| | and a Mn > 1,000 kg/mol, as described in | |
| | U.S. Pat. No. 5,296,547; obtained under the trade | |
| | designation KRATON D1340 | |
| K1126 | (SI)n radial block copolymer having a styrene | Kraton Corporation, |
| | content of 19%, a diblock content of 30%, and | Houston, TX, USA |
| | a melt index of 15 g/10 min at 200° C./5 kg | |
| | obtained under the trade designation | |
| | KRATON 1126 | |
| ZQK100 | Tackifier; aliphatic C5 resin with ring-and-ball | Zeon Chemicals, |
| | softening point of 100° C., obtained under the | Louisville, KY, USA |
| | trade designation ZEON QUINTONE K100 | |
| I1520 | Antioxidant obtained under the trade | BASF, |
| | designation IRGANOX 1520 | Ludwigshafen, |
| | | Germany |
| Toluene | Toluene, HPLC grade | Sigma-Aldrich |
| n-heptane | n-heptane | Sigma-Aldrich |
| MEK | methyl ethyl ketone | Sigma-Aldrich |

### Block Copolymer Synthesis

### Purification

Cyclohexane (CHX) OMNISOLV HPLC grade was purified via solvent purification system (Pure Process Technology LLC Nashua N.H. 03064). Isoprene (Aldrich 99%) was purified via stirring over calcium hydride (Aldrich 95%) in a round bottom flask (RBF) attached to a short path distillation manifold for 14 hours followed by one freeze-pump-thaw and vacuum distillation to another RBF under vacuum containing dried di-n-butlymagnesium (Aldrich 1.0M in heptane) (5:1, v:v). After 1 hour, isoprene was distilled to a burette with a 0.5 inch (1.27 centimeters) glass stem and stop cock and stored under vacuum in dry ice isopropanol bath overnight. Styrene (Aldrich 99%) was purified via stirring over calcium hydride (Aldrich 95%) in a RBF attached to a short path distillation manifold for 14 hours followed by one freeze-pump-thaw and vacuum distillation to another RBF under vacuum containing dried di-n-butlymagnesium (Aldrich 1.0M in heptane) (5:1, v:v). After 1 hour, styrene was distilled to a burette with a 0.5 inch (1.27 centimeters) glass stem and stored under vacuum in a dry ice isopropanol bath overnight.

### Anionic Polymerization Setup

A 1 liter (L) round-bottomed flask (RBF) reactor with 5 #15 Ace Glass threaded ports was equipped with a glass stir bar. One threaded port was equipped with a side arm “T-connector” equipped with three 0.25 inch (6.35 millimeters) glass ports: two Teflon-capped valves to interface a vacuum/argon line and manometer along with an injection port equipped with a Teflon-lined septum for initiator injection. The appropriate number of burettes/solvent flasks were each attached with a 0.5 inch (1.27 centimeters) inner diameter (ID) Ace Glass bushing, O-ring, and Teflon ferrule (#15). The entire reactor was pumped down overnight. The reactor was then subjected to three cycles of flame drying under vacuum (<10-3 torr) followed by an argon backfill and purge.

### General Synthesis of A-B Diblock Copolymer

Two A-B diblock copolymers (BD1 and BD2) were prepared in the following manner utilizing the amount of styrene, isoprene, and initiator as summarized in Table 2.

A 1 L RBF with stopcock containing about 850 grams (g) of CHX was fitted to the reactor along with the styrene burette and isoprene burette. The reactor was pumped down to full vacuum (<10-3 torr), then charged to 3 pounds per square inch (psi) of pressure with argon and sealed. CHX was charged into the reactor and was heated with a water bath to 40° C. as monitored by internal probe. Upon equilibration, sec butyl lithium (1.7 M in hexane) initiator was injected in one portion into the CHX and allowed to stir for 10 minutes at which time styrene was added in one portion. Within 2 minutes the reaction changed from slight hazy yellow to orange red in color which in turned persisted indicating a living styrene polymerization. After 2 hours, an aliquot of the polymerization was pulled and H¹ NMR confirmed >99% conversion from absence of vinyl peaks associated with styrene (5.0-6.0 parts per million (ppm)). Isoprene was then added, which resulted in a disappearance of color; approximately ⅓ portion was added and 10 minutes later the remaining portion was added. The reaction was allowed to proceed at 40° C. for 19 hours at which time the reaction was terminated with spargged isopropanol. The solution was precipitated into methanol (approximately 10 L) and dried in vacou yielding about 100 g of white viscoelastic polymer.

### GENERAL SYNTHESIS of A−A/B−B TAPERED MIDBLOCK COPOLYMER

Three A−A/B-A (TD1, TD2 and TD3) were prepared in the following manner utilizing the amount of styrene, isoprene, and initiator as summarized in Table 2.

A 1 L RBF with stopcock containing about 850 g of CHX was fitted to the reactor along with the styrene burette and isoprene burette. The reactor was pumped down to full vacuum (<10-3 torr), then charged to 3 psi of pressure with argon and sealed. CHX was charged into the reactor and was heated with a water bath to 40° C. as monitored by internal probe. Upon equilibration, both styrene and isoprene were added in one portion followed by sec butyl lithium (1.7 M in hexanes) initiator injected in one portion directly into the CHX. No color change was observed and the reaction was allowed to proceed for 14 hours at which time it changed to an orange red color indicating living styrene ends and at which time the reaction was terminated with 10 mL spargged isopropanol and was precipitated into methanol (approximately 10 L) and dried in vacou yielding 110 g of white viscoelastic polymer.

The synthesized A-B and A−A/B−B block copolymer were analyzed by NMR and GPC according to the following test methods.

### Gel Permeation Chromotography (GPC) Test Method

Samples were prepared in tetrahydrofuran (THF, stabilized with 250 ppm BHT) by weighing sample and solvent; the target concentration was approximately 3 milligrams/milliliter. The sample solution was then filtered through a 0.45 micrometer PTFE syringe filter and analyzed by GPC under the following conditions:

| | |
|---|---|
| Instrument: | Agilent 1260 LC |
| Column set: | Waters Styragel HR 5E, 300 × 7.8 mm I.D. |
| Col. Heater: | 40° C. |
| Mobile phase: | THF (stabilized with 250 ppm BHT) at 1.0 mL/min |
| Injection volume: | 30 microliters |
| Detector (s): | Wyatt DAWN HELEOS-II 18 angle Light Scattering |
| | detector |
| | Wyatt Optilab T-rEX Differential Refractive Index |
| | (DRI) detector |

Molecular weight results from GPC were determined using light scattering detection in THF eluent and ASTRA 6 from Wyatt Technology Corporation was used for data collection and analysis. The differential refractive index increment (dn/dc) of each sample was experimentally determined in the mobile phase or eluent using a Total Recovery Approach. Results are averages from duplicate injections and all dn/dc values are in mL/g. The experimental dn/dc values were used for molecular weight calculations.

Mₙ=Number-average molecular weight

M_{w}=Weight-average molecular weight

Ð=Dispersity=M_{w}/Mₙ

### Nuclear Magnetic Resonance (NMR) Test Method

Proton NMR spectroscopy was conducted on the synthesized block copolymers using a Bruker AVANCE III 500 MHz NMR spectrometer. Quantitative proton NMR spectra were recorded wall a 15° ¹H excitation pulse, a repetition rate of 5 sec, and acquisition time of 4 seconds.

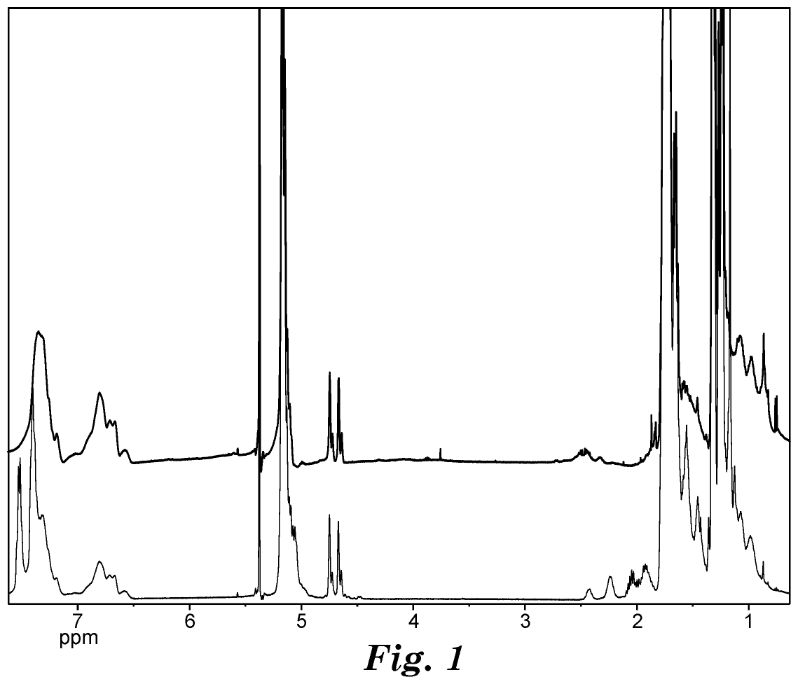

The NMR results are depicted in FIG. 1. The polystyrene-polyisoprene (A-B) diblock (BD2) is the top plot and the A−A/B-A block copolymer is the bottom plot, TD2.

The NMR of BD2 shows two peaks: Peak A the region from 6.3-6.9 ppm corresponds to the ortho protons residue and integrate to 2 and Peak B is the region from 6.9-7.3 ppm and corresponds to the chemical shifts of the meta (2) and para (1) protons with a total integration of 3. The total integration is 5 or a ratio of 1.5:1 (3:2), accounting for all the polystyrene aromatic protons.

The NMR of TD2 shows a ratio in excess of 3:2 (area of peaks between 6.9-7.3 ppm to area of peaks between 6.3-6.9 ppm). When a styrene repeat unit is followed by an isoprene unit, the backbone unsaturation causes a downfield shift for all of the residues corresponding to styrene's aromatic peaks (ortho, meta, and para) to fall in the 6.9-7.4 ppm range. Backbone unsaturation leaves the ortho peak unshielded leading to the difference of chemical shift values. In the polystyrene-polyisoprene (A-B) diblock (BD2) there is only one of these aforementioned repeat units; therefore its effect on integration is negligible.

The percentage of styrene in the (e.g. tapered) poly(styrene/isoprene) copolymer block of TD2 was calculated via ¹H NMR in CD₂CL₂ with reference peak at 5.25 parts per million (ppm), not to overlap the aromatic region between 6-8 ppm. Calculation of the downshifted (tapered) styrene units is done through normalization of Peak A to 2. The area from 6.9-7.4 ppm is then subtracted by 3 (corresponding to block residue meta and para peaks). The adjusted area is then divided by 5 to normalize each proton resulting in the amount of tapered styrene. Comparing this number to 1 (area of 2 ortho residues of block styrene normalized by dividing by 2 from Peak A) gives the mole ratio of polystyrene block versus (e.g. tapered) styrene of the poly(styrene/isoprene) copolymer block.

Further evidence of tapering is seen in the Peak C region of 2.0-2.5 ppm; where other residues are seen for TD2. These shifts correspond to the allylic backbone peaks and are further downfield shifted to be adjacent to the aromatic ring(s) of styrene next to isoprene repeat units. In the case of BD2, residues in such region are not evident.

TABLE 2
Summary of Synthesized A-B (BD1 and BD-2) and
A-A/B-B (TD-1, TD-2, and TD-3) Block Copolymers

| | Styrene, | Isoprene, | Sec butyl lithium | Solids |
|---|---|---|---|---|
| | mol | mol | initiator mmol | (wt. %) in |
| Ex. | (wt. %) | (wt. %) | (wt. %) | cyclohexane |
| BD1 | 0.25 (24.76%) | 1.16 (75.16%) | 1.31 (0.08%) | 7.66 |
| TD1 | 0.35 (23.71%) | 1.72 (76.22%) | 1.69 (0.07%) | 18.76 |
| BD2 | 0.27 (24.37%) | 1.28 (75.57%) | 0.96 (0.05%) | 11.60 |
| TD2 | 0.29 (22.46%) | 1.53 (77.49%) | 1.12 (0.05%) | 14.76 |
| TD3 | 0.30 (18.50%) | 1.31 (81.36%) | 1.34 (0.08%) | 11.90 |

TABLE 3
NMR & GPC Analysis of Final Polymer

| | | Styrene of | Styrene of | | | |
|---|---|---|---|---|---|---|
| | Total | Polystyrene | Poly(styrene/isoprene) | | | |
| | Styrene, | Block, | Copolymer Block, | Isoprene, | Mn, | |
| Example | wt. % | wt. % | wt. % | wt. % | g/mol | Polydispersity |
| BD1 | 28.10 | 28.10 | 0.00 | 71.90 | 76,800 | 1.00 |
| TD1 | 31.70 | 13.10 | 18.60 | 68.30 | 86,500 | 1.00 |
| BD2 | 26.20 | 26.20 | 0.00 | 73.80 | 120,800 | 1.02 |
| TD2 | 21.40 | 11.60 | 9.90 | 78.60 | 113,700 | 1.09 |
| TD3 | 26.70 | 12.00 | 14.70 | 73.30 | 68,800 | 1.13 |

### Adhesive Preparation

The synthesized styrenic block copolymer elastomers described above were combined with Kraton D1340 or Kraton 1126, aliphatic C5 tackifying resin (Zeon Quintone K100), and Irganox 1520 (BASF) antioxidant in the amount indicated in the following tables. Samples were compounded at 45% solids in HPLC grade toluene in glass jars and allowed to roll until thoroughly mixed (about four days). Samples were coated with a flatbed knife onto silicone release liner using a flatbed knife coater connected to a drying over with a 30 foot drying path at a line speed of 9 feet per minute with an average oven temperature profile of 160° F. to give a nominal coat weight of 10 grains per 24 square inches (1.66 mils, 41.5 microns). The adhesive side of coated release liner was laminated to plasma treated 2 mil (0.05 millimeter) PET and rolled thoroughly with a 15 pound roller. Samples were conditioned at 50% relative humidity and 23° C. for at least 24 hours prior to testing.

### Adhesive Test Methods

### Peel Adhesion Test Method

Adhesion testing was completed following ASTM D 3330/D 3330M (2010). Briefly, stainless steel panels were cleaned with n-heptane and methyl ethyl ketone (MEK). Tape samples were razor slit to 1 inch (2.54 centimeters (cm)) and applied to stainless steel panels and rolled down with a 4.5 pound roller. The steel panel was affixed in the stationary jaw of the Instron (Model No. 3365, Norwood, Mass.) and peeled at an angle of 180 degree at varying crosshead speeds of 40 (101.6 cm), 12.6 (32.0 cm), 4, 1.26, 0.4, 0.126, 0.04 (0.10 cm) inch per minute (ipm) and at varying temperatures 25, 10, 0 and −10° C. Dwell time for samples was approximately one minute. The average of two replicates is reported and inputted into statistical software for analysis. The average peel adhesion values obtained at 40 ipm (101.6 cm/min) and 12.6 ipm (32.0 cm/min) at 50% relative humidity and 25° C. is reported in the tables. All the average peel adhesion values were utilized for generating the peel rate master curve.

### Shear Adhesion Test Method

Shear adhesion was tested according to ASTM D 3654/D 3654M (2011) except that the tape sample applied to the stainless steel panel had a length (in the direction of gravity) of 1 inch (2.54 cm) rather than 0.5 inches (1.27 cm), Briefly, stainless steel panels were cleaned with n-heptane and MEK. 1 inch (2.54 cm)×0.5 inch (1.27 cm) PSA tape samples on plasma treated 2 mil (0.05 millimeter) PET were applied to stainless steel panels and rolled down with a 15 pound (6.8 kilogram (kg)) roller. 1 kg weight was hung from the tape and time to failure was recorded.

### Rheological Analysis Test Method

Rheological data was gathered using a DHR2 rheometer (TA Instruments, New Castle, Del.) having 8 millimeter (mm) parallel plates in oscillatory shear. Temperatures from −65° C. to 100° C. were scanned in 10° C. increments at angular frequencies ranging from 0.1 to 100 radians/second acquiring data at three points per decade. The temperature of the maximum loss tangent (tan δ) at 1 Hz in oscillatory shear was reported as the glass transition temperature.

TABLE 4
Pressure Sensitive Adhesive Compositions

| | | | Synthesized Block | | | |
|---|---|---|---|---|---|---|
| | Second Block | | Copolymer, | | | |
| | Copolymer, | | parts (wt. %) | | Tackifier, | Antioxidant, |
| | parts (wt. %) | | A-B | | pphr (wt. %) | pphr (wt. %) |
| Ex. | K1340 | K1126 | Diblock | A-A/B-B | ZQK100 | I1520 |
| EX-1 | 60 | — | — | TD1, 40 | 45 | 1 |
| | (41.10%) | | | (27.40%) | (30.82%) | (0.68%) |
| CE-1 | 60 | — | BD1, 40 | — | 45 | 1 |
| | (41.10%) | | (27.40%) | | (30.82%) | (0.68%) |
| EX-2 | — | 60 | — | TD1, 40 | 45 | 1 |
| | | (41.10%) | | (27.40%) | (30.82%) | (0.68%) |
| CE-2 | — | 60 | BD1, 40 | — | 45 | 1 |
| | | (41.10%) | (27.40%) | | (30.82%) | (0.68%) |
| EX-3 | 60 | — | — | TD1, 40 | 70 | 1 |
| | (35.09%) | | | (23.39%) | (40.94%) | (0.58%) |
| CE-3 | 60 | — | BD1, 40 | — | 70 | 1 |
| | (35.09%) | | (23.39%) | | (40.94%) | (0.58%) |
| EX-4 | — | 60 | — | TD1, 40 | 70 | 1 |
| | | (35.09%) | | (23.39%) | (40.94%) | (0.58%) |
| CE-4 | — | 60 | BD1, 40 | — | 70 | 1 |
| | | (35.09%) | (23.39%) | | (40.94%) | (0.58%) |
| EX-5 | 85 | — | — | TD1, 15 | 45 | 1 |
| | (58.22%) | | | (10.27%) | (30.82%) | (0.68%) |
| CE-5 | 85 | — | BD1, 15 | — | 45 | 1 |
| | (58.22%) | | (10.27%) | | (30.82%) | (0.68%) |
| EX-6 | — | 85 | — | TD1, 15 | 45 | 1 |
| | | (58.22%) | | (10.27%) | (30.82%) | (0.68%) |
| CE-6 | — | 85 | BD1, 15 | — | 45 | 1 |
| | | (58.22%) | (10.27%) | | (30.82%) | (0.68%) |
| EX-7 | 85 | — | — | TD1, 15 | 70 | 1 |
| | (49.71%) | | | (8.77%) | (40.94%) | (0.58%) |
| CE-7 | 85 | — | BD1, 15 | — | 70 | 1 |
| | (49.71%) | | (8.77%) | | (40.94%) | (0.58%) |
| EX-8 | — | 85 | — | TD1, 15 | 70 | 1 |
| | | (49.71%) | | (8.77%) | (40.94%) | (0.58%) |
| CE-8 | — | 85 | BD1, 15 | — | 70 | 1 |
| | | (49.71%) | (8.77%) | | (40.94%) | (0.58%) |
| EX-9 | 60 | — | — | TD2, 40 | 45 | 1 |
| | (41.10%) | | | (27.40%) | (30.82%) | (0.68%) |
| CE-9 | 60 | — | BD2, 40 | — | 45 | 1 |
| | (41.10%) | | (27.40%) | | (30.82%) | (0.68%) |
| EX-10 | — | 60 | — | TD2, 40 | 45 | 1 |
| | | (41.10%) | | (27.40%) | (30.82%) | (0.68%) |
| CE-10 | — | 60 | BD2, 40 | — | 45 | 1 |
| | | (41.10%) | (27.40%) | | (30.82%) | (0.68%) |
| EX-11 | 60 | — | — | TD2, 40 | 70 | 1 |
| | (35.09%) | | | (23.39%) | (40.94%) | (0.58%) |
| CE-11 | 60 | — | BD2, 40 | — | 70 | 1 |
| | (35.09%) | | (23.39%) | | (40.94%) | (0.58%) |
| EX-12 | — | 60 | — | TD2, 40 | 70 | 1 |
| | | (35.09%) | | (23.39%) | (40.94%) | (0.58%) |
| CE-12 | — | 60 | BD2, 40 | — | 70 | 1 |
| | | (35.09%) | (23.39%) | | (40.94%) | (0.58%) |
| EX-13 | 85 | — | — | TD2, 15 | 45 | 1 |
| | (58.22%) | | | (10.27%) | (30.82%) | (0.68%) |
| CE-13 | 85 | — | BD2, 15 | — | 45 | 1 |
| | (58.22%) | | (10.27%) | | (30.82%) | (0.68%) |
| EX-14 | — | 85 | — | TD2, 15 | 45 | 1 |
| | | (58.22%) | | (10.27%) | (30.82%) | (0.68%) |
| CE-14 | — | 85 | BD2, 15 | — | 45 | 1 |
| | | (58.22%) | (10.27%) | | (30.82%) | (0.68%) |
| EX-15 | 85 | — | — | TD2, 15 | 70 | 1 |
| | (49.71%) | | | (8.77%) | (40.94%) | (0.58%) |
| CE-15 | 85 | — | BD2, 15 | — | 70 | 1 |
| | (49.71%) | | (8.77%) | | (40.94%) | (0.58%) |
| EX-16 | — | 85 | — | TD2, 15 | 70 | 1 |
| | | (49.71%) | | (8.77%) | (40.94%) | (0.58%) |
| CE-16 | — | 85 | BD2, 15 | — | 70 | 1 |
| | | (49.71%) | (8.77%) | | (40.94%) | (0.58%) |

TABLE 5
Pressure Sensitive Adhesive Compositions

| | Synthesized | | |
|---|---|---|---|
| | A-A/B-B Block | Tackifier | Antioxidant |
| | Copolymer, | (ZQK100), | (I1520), |
| Ex. | parts (wt %) | pphr (wt %) | pphr (wt %) |
| EX-17 | TD3, 100 (58.48%) | 70 (40.94%) | 1 (0.58%) |
| EX-18 | TD3, 100 (68.49%) | 45 (30.82%) | 1 (0.68%) |

TABLE 6
Properties of Adhesive Compositions

| | Initial Peel to Stainless Steel, 50% relative | | | | | |
|---|---|---|---|---|---|---|
| | humidity and 23° C., N/cm | | | | | |
| | 101.6 | Difference | | Difference | | |
| | cm/min* | between | 32.0 | between | Shear, | Shear |
| Ex. | N/cm | EX and CE | cm/min* | EX and CE | minutes | Failure Mode |
| EX-1 | 8.3 | −1.2 | 6.7 | −2.1 | 1426 | Pop-off |
| CE-1 | 9.5 | | 8.8 | | 23051 | >10,000 |
| | | | | | | minutes |
| EX-2 | 8.6 | −0.6 | 7.6 | −0.8 | 2798 | Pop-off |
| CE-2 | 9.2 | | 8.4 | | 23040 | >10,000 |
| | | | | | | minutes |
| EX-3 | 8.4 | −3.6 | 8.2 | −2.5 | 2519 | Pop-off |
| CE-3 | 12.0 | | 10.7 | | 22877 | >10,000 |
| | | | | | | minutes |
| EX-4 | 7.5 | −3.3 | 7.9 | −2.5 | 17448 | Pop-off |
| CE-4 | 10.8 | | 10.4 | | 22865 | >10,000 |
| | | | | | | minutes |
| EX-5 | 7.6 | −0.8 | 5.9 | −1.9 | 3461 | Pop-off |
| CE-5 | 8.4 | | 7.8 | | 22883 | >10,000 |
| | | | | | | minutes |
| EX-6 | 8.8 | −0.2 | 7.4 | −0.5 | 14592 | Pop-off |
| CE-6 | 9.0 | | 7.9 | | 23116 | >10,000 |
| | | | | | | minutes |
| EX-7 | 10.1 | −0.8 | 8.8 | −0.9 | 13124 | Pop-off |
| CE-7 | 10.9 | | 9.7 | | 22859 | >10,000 |
| | | | | | | minutes |
| EX-8 | 8.5 | −2.4 | 7.6 | −2.0 | 5074 | Pop-off |
| CE-8 | 10.9 | | 9.6 | | 22890 | >10,000 |
| | | | | | | minutes |
| EX-9 | 9.0 | −0.3 | 8.7 | −0.3 | 23144 | >10,000 |
| | | | | | | minutes |
| CE-9 | 9.3 | | 9.0 | | 23104 | >10,000 |
| | | | | | | minutes |
| EX-10 | 8.1 | −0.8 | 7.3 | −1.0 | 23067 | >10,000 |
| | | | | | | minutes |
| CE-10 | 8.9 | | 8.3 | | 22915 | >10,000 |
| | | | | | | minutes |
| EX-11 | 8.2 | −2.4 | 8.3 | −2.1 | 22945 | >10,000 |
| | | | | | | minutes |
| CE-11 | 10.6 | | 10.4 | | 23000 | >10,000 |
| | | | | | | minutes |
| EX-12 | 6.8 | −4.6 | 7.0 | −3.5 | 23122 | >10,000 |
| | | | | | | minutes |
| CE-12 | 11.4 | | 10.5 | | 23136 | >10,000 |
| | | | | | | minutes |
| EX-13 | 8.3 | −0.0 | 7.8 | 0.1 | 23023 | >10,000 |
| | | | | | | minutes |
| CE-13 | 8.3 | | 7.7 | | 23088 | >10,000 |
| | | | | | | minutes |
| EX-14 | 8.4 | −0.6 | 7.4 | −0.9 | 23016 | >10,000 |
| | | | | | | minutes |
| CE-14 | 9.0 | | 8.3 | | 23074 | >10,000 |
| | | | | | | minutes |
| EX-15 | 9.7 | −0.2 | 9.2 | −0.1 | 22905 | >10,000 |
| | | | | | | minutes |
| CE-15 | 9.9 | | 9.3 | | 23130 | >10,000 |
| | | | | | | minutes |
| EX-16 | 8.6 | −2.1 | 8.0 | −1.2 | 23110 | >10,000 |
| | | | | | | minutes |
| CE-16 | 10.7 | | 9.2 | | 23010 | >10,000 |
| | | | | | | minutes |

*Refers to the Instron cross-head speed; “Pop-off” refers to adhesive failure (i.e., the adhesive fell off of the substrate)

TABLE 7
Properties of Adhesive Compositions

| | Initial Peel to Stainless Steel, 50% | | |
|---|---|---|---|
| | relative humidity and 23° C., N/cm | | Shear to Stainless |
| Example | 101.6 cm/min | 32.0 cm/min | Steel, minutes |
| EX-17 | 10.9 +/− 0.1 | 6.3 +/− 0.5 | 15 +/− 2 |
| EX-18 | 7.4 +/− 0.4 | 3.7 +/− 0.3 | 25 +/− 0 |

Both samples failed cohesively

TABLE 8
Properties of Adhesive Compositions

| | G′ at 25° C. and 1 | |
|---|---|---|
| Example | Hz, Pa | Tg at 1 Hz, ° C. |
| EX-11 | 113900 (0.11 MPa) | −16.0 |
| CE-11 | 123938 (0.12 MPa) | −18.8 |

### Preparation of Painted Drywall

Drywall panels (obtained from Materials Company, Metzger Building, St. Paul, Minn.) were painted with Interior Acrylic Latex Ben Bone White Paint obtained from Sherwin Williams.

Procedure for painting drywall with paints: a first coat of paint was applied to a drywall panel by paint roller, followed by air drying for 24 hours at ambient conditions. A second coat of paint was applied dried at ambient conditions for 24 hours. The panel was allowed to dry at room temperature for 7 days. Then the panel was stored at ambient conditions until use.

### Preparation of Stretch-Release Strip

The adhesive of EX-11 was diluted to 50% solids in HPLC grade toluene in glass jars and allowed to roll until thoroughly mixed. Samples were coated with a flatbed knife onto silicone release liner using a flatbed knife coater connected to a drying over with a 30 foot drying path at a line speed of 9 feet per minute with an average oven temperature profile of 160° F. to give a nominal coat weight of 17 grains per 24 square inches (2.8 mil thickness). The adhesive side of the coated release liner was laminated to both major surface of a primed composite film-foam-film (31 mil 6 lb. foam with 1.8 mil polyethylene film on both sides of the foam) backing using an automated roller at a nominal pressure of 20 pounds per square inch (PSI) on speed setting 3 feet/minute (0.91 meters/minute). Samples were die cut into ½ inch×½ inch (1.27 centimeter (cm)×1.27 cm) squares used for shear testing. Samples were conditioned at 50% relative humidity and 23° C. for at least 24 hours prior to testing.

### Shear Adhesion Testing of Stretch-Release Strip

The adhesive coated surface of the Stretch-Release-Strip was adhered to the painted drywall. A 6.8 kg roller was passed over the test adhesive at 12 inches/minute (30.5 cm/minute). The samples were mounted in a vertical position and allowed to dwell for 60 min at 72° F. (22° C.) 50% relative humidity before attaching a 1 kg load to the adhesive. Samples were hung until failure or until 25,000 minutes had elapsed. An average of 3 samples was reported.

The average shear adhesion of the Stretch-Release-Strip with the adhesive composition of EX. 11 was 5331 minutes.

All cited references, patents, and patent applications in the above application for letters patent are herein incorporated by reference in their entirety in a consistent manner. In the event of inconsistencies or contradictions between portions of the incorporated references and this application, the information in the preceding description shall control. The preceding description, given in order to enable one of ordinary skill in the art to practice the claimed disclosure, is not to be construed as limiting the scope of the disclosure, which is defined by the claims and all equivalents thereto.

1. An adhesive composition comprising a block copolymer comprising a polyvinyl aromatic block and a poly(vinyl aromatic/isoprene) copolymer block; and a tackifier.

2. The adhesive composition of claim 1 wherein the block copolymer has the general structure:
A−A/B or A−A/B−B
wherein
A is the polyvinyl aromatic block;
B is a polyisoprene block; and
A/B is a poly(vinyl aromatic/isoprene) copolymer block.

3. The adhesive composition of claim 1 wherein the block copolymer has a styrene content ranging from 10 wt. % to 50 wt. %.

4. The adhesive composition of claim 1 wherein the block copolymer has a number average molecular weight ranging from 50,000 to 250,000 g/mole.

5. The adhesive composition of claim 1 wherein the block copolymer has a polydispersity ranging from 1 to 1.5.

6. The adhesive composition of claim 1 wherein the adhesive composition comprises 5 to 80 wt. % of the block copolymer.

7. The adhesive composition of claim 1 wherein a nuclear magnetic spectroscopy of the block copolymer exhibits peaks in the region from 6 to 7.5 and the total integration of the peak is greater than 3:2.

8. The adhesive composition of claim 1 wherein the poly(vinyl aromatic/isoprene) copolymer block (AB) comprises 5 to 30 wt. % styrene.

9. The adhesive composition of claim 1 wherein the adhesive composition further comprises a second block copolymer comprising at least two polyvinyl aromatic blocks and one or more conjugated diene blocks.

10. The adhesive composition of claim 9 wherein the conjugated diene block of the second block copolymer is polyisoprene.

11. The adhesive composition of claim 9 wherein the adhesive comprises the second block copolymer in an amount equal to or greater than the block copolymer comprising the polyvinyl aromatic block and poly(vinyl aromatic/isoprene) copolymer block.

12. The adhesive composition of claim 9 wherein the second block copolymer has a number average molecular weight ranging from 50,000 to 2,000,000 g/mole.

13. The adhesive composition of claim 1 wherein the adhesive is a pressure sensitive adhesive composition having a glass transition temperature less than 25° C. or 0° C.

14. The adhesive composition of claim 1 wherein the adhesive is a pressure sensitive adhesive composition having an elastic modulus, G′, of no greater than 3×10⁵ Pa at 25° C. and 1 Hz.

15. The adhesive composition of claim 1 wherein the adhesive is a pressure sensitive adhesive having a shear adhesion to stainless steel greater than 10,000 minutes according to ASTM D3654 (2011) using a bonded area of 2.54 cm by 1.27 cm.

16. The adhesive composition of claim 1 wherein the adhesive is a pressure sensitive adhesive having a shear adhesion to painted drywall greater than 5,000 minutes according to ASTM D3654 (2011) using a bonded area of 2.54 cm by 1.27 cm.

17. The adhesive composition of claim 1 wherein the adhesive is a pressure sensitive adhesive composition having an initial 180 degree peel adhesion to stainless steel of at least 0.5, 1, 2, 3, 4, or 5 N/cm at a peel rate of 12.6 inches (32 cm)/minutes.

18. The adhesive composition of claim 1 wherein a plot of initial 180 degree peel adhesion to stainless steel as a function of the log of the peel propagation rate has a slope less than or equal to 2.66 N*min/in² (2.54 cm²) for temperatures ranging from 0° C. to 25° C. and peel propagation rates ranging from 1 inch (2.54 cm)/minute to 20 inches (50.8 cm)/min.

19. An adhesive article comprising:
a substrate; and
a layer of adhesive composition disposed on the substrate, wherein the adhesive comprises a block copolymer comprising a polyvinyl aromatic block and a poly(vinyl aromatic/isoprene) copolymer block; and tackifier.

20. The adhesive article of claim 19 wherein the substrate is a release liner or a film.
